(19) United States
(12) Patent Application Publication
(10) Pub. No.: US 2026/0174615 A1
(43) Pub. Date: Jun. 25, 2026

(54) Personalized Coffin Cover

(71) Applicant: Janice Gray, Wellesley (CA)

(72) Inventor: Janice Gray, Wellesley (CA)

(21) Appl. No.: 19/254,339

(22) Filed: Jun. 30, 2025

Related U.S. Application Data
(60) Provisional application No. 63/737,945, filed on Dec. 23, 2024.

(51) Int. Cl. A61G 17/04

(52) U.S. Cl. CPC A61G 17/042

(57) ABSTRACT

The present invention relates to a customized coffin cover designed to provide a personalized tribute to a deceased individual. The coffin cover comprises a top surface featuring a plurality of images, messages, and quotes associated with the deceased. A machine-readable interactive element, such as a QR code, is disposed on the top surface, allowing access to a digital memorial page containing the deceased's biography, images, videos, and voice recordings. Additionally, the coffin cover may feature a scent-release mechanism to emit personalized fragrances. The cover can be configured as a full wrap or partial wrap and includes interchangeable panels for different ceremonies. A bottom surface with an adhesive layer provides a secure fit across various coffin sizes. The cover can be made from biodegradable materials, promoting eco-friendly disposal.

### CROSS-REFERENCE TO RELATED APPLICATION

The present application claims priority to, and the benefit of, U.S. Provisional Application No. 63/737,945, which was filed on Dec. 23, 2024, and is incorporated herein by reference in its entirety.

### FIELD OF THE INVENTION

The present invention generally relates to funeral accessories and memorial customization solutions. More specifically, the invention pertains to a customized coffin cover that serves as a personalized tribute to a deceased individual. Accordingly, this disclosure makes specific reference thereto. Nonetheless, it is to be appreciated that aspects of the present invention are also equally applicable to other like applications, devices, and methods of manufacture.

### BACKGROUND

By way of background, traditional coffins are commonly constructed from materials such as metal, wood, or composite materials, and often feature standardized designs with minimal aesthetic variation. While some coffins may include decorative engravings, fabric linings, or polished finishes, they generally lack personalized elements that truly reflect the life and personality of the deceased individual.

For many families, the funeral process is not only a means of saying goodbye but also an opportunity to honor and celebrate the life of their loved one. However, existing coffins do not provide an effective way to incorporate customized visual elements, personal memories, or interactive tributes, leaving families with limited options to create a more meaningful farewell.

Additionally, in modern funerals, there is a growing demand for alternative memorialization methods, including digitally integrated tributes, eco-friendly burial solutions, and interactive remembrance features. Despite this, no commercially available solution currently allows for fully customizable coffin designs, nor do existing coffin options support the integration of digital memorial content that could enhance the mourning experience. People desire a customized coffin cover that allows families to personalize a loved one's final resting place with images, quotes, and tributes.

Therefore, there exists a long-felt need in the art for a customizable coffin cover that allows families to transform a standard coffin into a unique representation of the deceased individual. There is a long-felt need for a coffin cover system that enhances the memorialization of the deceased. Additionally, there is a long-felt need for a coffin cover that features a machine-readable interactive element, such as a QR code, which can be scanned by an electronic device to access a digital memorial page. Furthermore, there is a long-felt need for a funeral solution that supports environmentally sustainable practices. More specifically, there exists a long-felt need in the art for coffin covers with a scent-release mechanism, allowing families to incorporate fragrances associated with the deceased. Also, there is a long-felt need in the art for a coffin cover that celebrates the person's passions and life, replacing the boring and cold exterior of a standard coffin. Finally, there is a long-felt need for an innovative solution that offers a way for people to mourn their deceased loved ones in a celebratory manner.

The subject matter disclosed and claimed herein, in one embodiment, comprises a customized coffin cover system. The system includes a coffin cover with a top surface, the top surface being configured to overlay the exterior of a coffin. The top surface features a plurality of personalized indicia, such as images, messages, and quotes, that visually represent the deceased individual's life, personality, and values. The cover further comprises a machine-readable interactive element, such as a QR code, that is accessible via an electronic mobile device, allowing users to retrieve digital memorial content, including biographies, photographs, videos, voice recordings, or AI-generated voice messages. Additionally, the coffin cover includes a bottom surface with an adhesive layer, which allows for secure attachment to the coffin while accommodating various coffin shapes and sizes.

In this manner, the customized coffin cover of the present invention fulfills the long-felt need for a personalized and meaningful funeral solution by offering a visually customized tribute, interactive digital memorial access, eco-friendly materials, and sensory enhancements. The adhesive-backed wrap design ensures a secure fit across various coffin sizes, allowing for full or partial coffin coverage based on user preferences. The cover offers a way for people to mourn their deceased loved ones in a celebratory manner.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a customized coffin cover device. The customized coffin cover device includes a top surface configured to be placed on an exterior of a coffin, wherein the top surface includes a plurality of personalized indicia selected from the group consisting of images, messages, and quotes associated with a deceased individual. A machine-readable interactive element is disposed on the top surface, wherein the machine-readable interactive element is configured to be scanned by an electronic mobile device to access a digital memorial page associated with the deceased individual, the digital memorial page includes at least one of a biography, pictures, videos, voice recordings, or AI-generated voice messages of the deceased individual. The bottom surface of the cover device includes an adhesive layer, wherein the adhesive layer is configured to secure the coffin cover to a coffin and accommodate different shapes and sizes of the coffin.

In another aspect, a customized coffin cover is disclosed. The customized coffin cover includes a top surface configured to be placed on a coffin, wherein the top surface is composed of a thermo-chromatic material that is configured to change color based on exposure to light. A plurality of customized indicia are printed on the top surface, wherein the indicia include at least one of images, quotes, or religious symbols associated with a deceased individual. A scent-release mechanism is embedded in the top surface, wherein the scent-release mechanism is configured to emit a custom fragrance associated with the deceased individual, the fragrance being selected from the group consisting of perfume, flowers, natural scents, or other familiar aromas. One or more interchangeable panels, wherein the interchangeable panels allow the coffin cover to be customized for different ceremonies by replacing portions of the cover with alternative designs, themes, or colors.

In one embodiment, a manufacturing process for the coffin cover includes selecting a material for the coffin cover, wherein the material is selected from the group consisting of vinyl, bamboo fiber, rice paper, and biodegradable polymer, receiving input related to images, quotes, and themes associated with the deceased individual, generating a custom wrap template based on coffin size and shape, printing the images and quotes on the selected material using at least one of vinyl printing, inkjet printing, or E-Ink printing, and applying a pre-cut adhesive layer to the bottom surface of the coffin cover.

In yet another aspect, a customized coffin cover is disclosed. The cover comprises a flexible wrap material configured to enclose a coffin, wherein the coffin cover can be adjusted to wrap, an entire coffin such that all sides of the coffin are covered, or a portion of the coffin, wherein only selected areas of the coffin are wrapped, a plurality of visual indicia are disposed on the top surface, wherein the indicia include photographs, quotes, natural-themed backgrounds, images of animals, hobbies, or professional symbols associated with a deceased individual, a machine-readable interactive element is integrated into the top surface, wherein the interactive element is configured to be accessed using an electronic mobile device to retrieve digital memorial content related to the deceased individual, and an adhesive bottom surface is configured to secure the coffin cover to the coffin without damage and to accommodate various coffin shapes and sizes.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a customized coffin cover of the present invention in accordance with the disclosed architecture;

FIG. 2 illustrates a flow chart depicting a process of manufacturing of the coffin cover device in accordance with one embodiment of the present invention;

FIG. 3 illustrates a perspective view of a coffin wrapped with a customized coffin cover device of the present invention in accordance with the disclosed structure;

FIG. 4 illustrates a close view of the coffin cover on a side surface of the coffin in accordance with one embodiment of the present invention;

FIG. 5 illustrates another embodiment of the customized coffin cover device of the present invention in accordance with the disclosed structure;

FIG. 6 illustrates a perspective view of an exemplary digital memorial page shown on scanning of the interactive element in accordance with one embodiment of the present invention; and

FIG. 7 illustrates a schematic view of features of a mobile application of one embodiment of the customized coffin cover device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a customizable coffin cover that allows families to transform a standard coffin into a unique representation of the deceased individual. There is a long-felt need for a coffin cover system that enhances the memorialization of the deceased. Additionally, there is a long-felt need for a coffin cover that features a machine-readable interactive element, such as a QR code, which can be scanned by an electronic device to access a digital memorial page. Furthermore, there is a long-felt need for a funeral solution that supports environmentally sustainable practices. More specifically, there exists a long-felt need in the art for coffin covers with a scent-release mechanism, allowing families to incorporate fragrances associated with the deceased. Also, there is a long-felt need in the art for a coffin cover that celebrates the person's passions and life, replacing the boring and cold exterior of a standard coffin. Finally, there is a long-felt need for an innovative solution that offers a way for people to mourn their deceased loved ones in a celebratory manner.

The present invention, in one exemplary embodiment, is a customized coffin cover. The cover comprises a flexible wrap material configured to enclose a coffin, wherein the coffin cover can be adjusted to wrap, an entire coffin such that all sides of the coffin are covered, or a portion of the coffin, wherein only selected areas of the coffin are wrapped, a plurality of visual indicia are disposed on the top surface, wherein the indicia include photographs, quotes, natural-themed backgrounds, images of animals, hobbies, or professional symbols associated with a deceased individual, a machine-readable interactive element is integrated into the top surface, wherein the interactive element is configured to be accessed using an electronic mobile device to retrieve digital memorial content related to the deceased individual, and an adhesive bottom surface is configured to secure the coffin cover to the coffin without damage and to accommodate various coffin shapes and sizes. Individuals may sign the device to give farewell messages or, they may be computer generated.

Reference will now be made in detail to the present preferred embodiments of the invention, examples of which are illustrated in the accompanying drawings. Wherever possible, the same reference numerals are used in the drawings and the description to refer to the same or like parts.

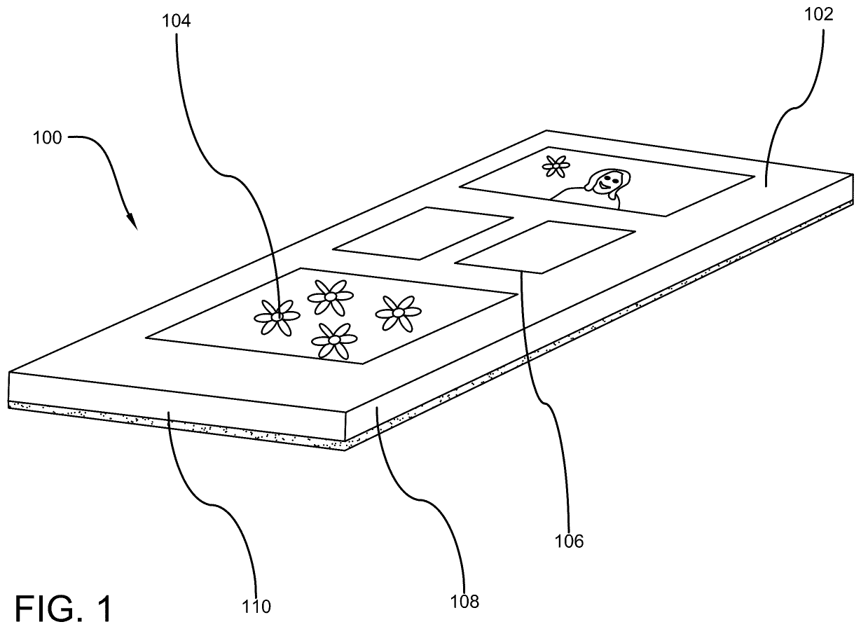

Referring initially to the drawings, FIG. 1 illustrates a perspective view of one embodiment of a customized coffin cover 100 of the present invention in accordance with the disclosed architecture. The customized coffin cover 100 of the present invention is a specially designed coffin cover that serves as a personalized tribute to a deceased individual. The coffin cover 100 is configured to be placed on the exterior of a coffin to provide a unique representation of the deceased person's life, memories, personality, etc. The personalized coffin cover 100 addresses the desire of families and loved ones to honor the deceased in a more personal and expressive way. More specifically, the coffin cover 100 includes a customized top surface 102 that includes a plurality of indicia 104 such as, but not limited to, images, messages, or quotes about the deceased. The top surface 102 is washable and may be made from a thermo-chromatic material that changes color based on light exposure.

A machine-readable interactive element 106, preferably, but not limited to, a QR code, is disposed on the top surface 102 and is configured to be accessed using a smart mobile device such as, but not limited to, a cell phone for accessing a digital memorial page 600 of the deceased wherein the digital memorial page may include biography, pictures, videos, or messages from family members, a voice recording or AI-generated voice messages from the deceased, and more.

The coffin cover device 100 has a bottom surface 108 which includes an adhesive layer 110 to attach the device 100 to a lid of a coffin. In one embodiment, the cover device 100 is made of a biodegradable material that may dissolve naturally over time, thereby leaving no environmental impact.

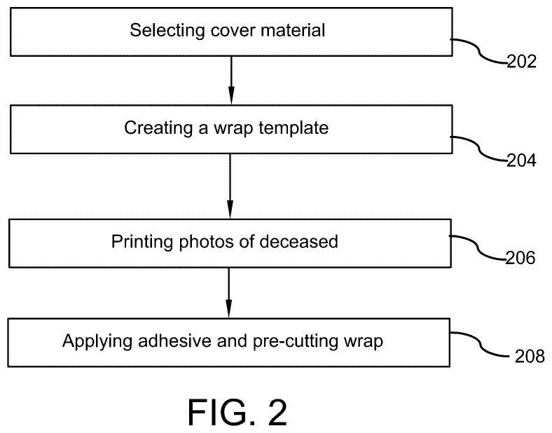

FIG. 2 illustrates a flow chart depicting a process of manufacturing of the coffin cover device 100 in accordance with one embodiment of the present invention. Initially, a cover material is selected (Step 202) wherein the material can be a high-quality vinyl material or eco-friendly material like rice paper, bamboo fiber, plant-based polymer, and more. Then, photos, quotes, and themes of the deceased are used for customization and a wrap template based on coffin size and shape is generated (Step 204). Thereafter, printing of the images is performed on the wrap material (Step 206) and printing may include one or more of vinyl printing, inkjet printing, E-Ink printing, and more. Finally, the pre-cut adhesive layer is applied, and the cover device is dimensioned using precision laser cutting for an exact fit for different coffin sizes (Step 208).

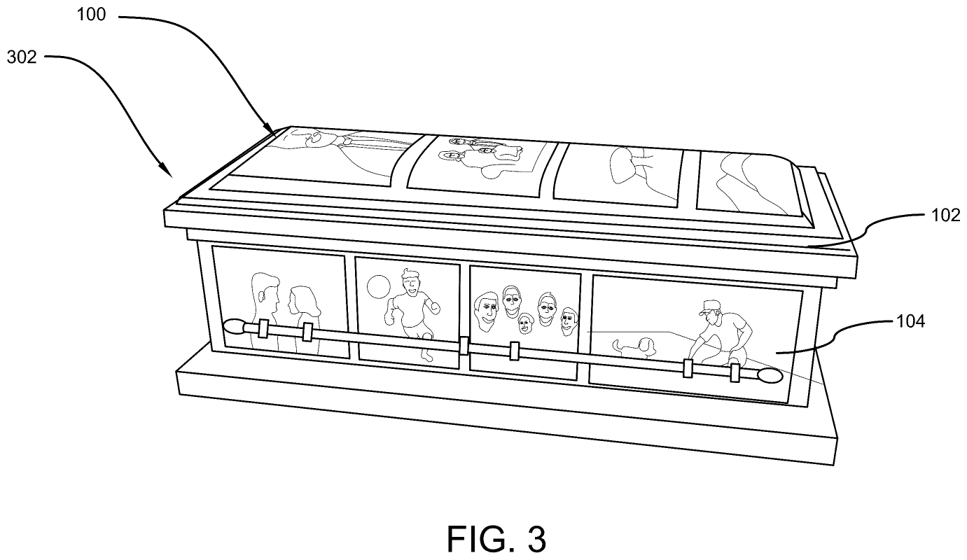

FIG. 3 illustrates a perspective view of a coffin wrapped with a customized coffin cover device 100 of the present invention in accordance with the disclosed structure. As illustrated, a coffin 302 is wrapped with one embodiment of the coffin cover device 100 such that all the sides of the coffin 302 are wrapped using the device 100. In some embodiments, based on preferences of the user, the cover device 100 may wrap only a portion of the coffin 302 such as, but not limited to, the lid of the coffin 302.

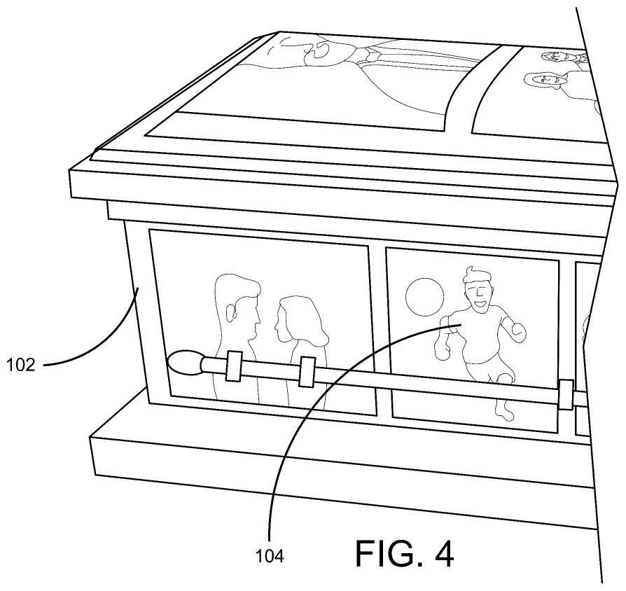

FIG. 4 illustrates a close view of the coffin cover 100 on a side surface of the coffin in accordance with one embodiment of the present invention. As illustrated, the cover 100 includes a plurality of indicia 104 that may represent attributes of the deceased. It should be noted that the indicia 104 include, but not limited to, photographs, quotes, messages, religious or spiritual symbols, Natural-themed backgrounds, and images of animals, hobbies, or professions related to the deceased.

The personalized coffin cover 100 can be used in traditional funerals, memorial services, cremation services, themed funerals, and more. The cover 100 can be impregnated with a scent 504, wherein the scent 504 may be associated with the deceased (e.g., their favorite perfume, flowers, or natural smells).

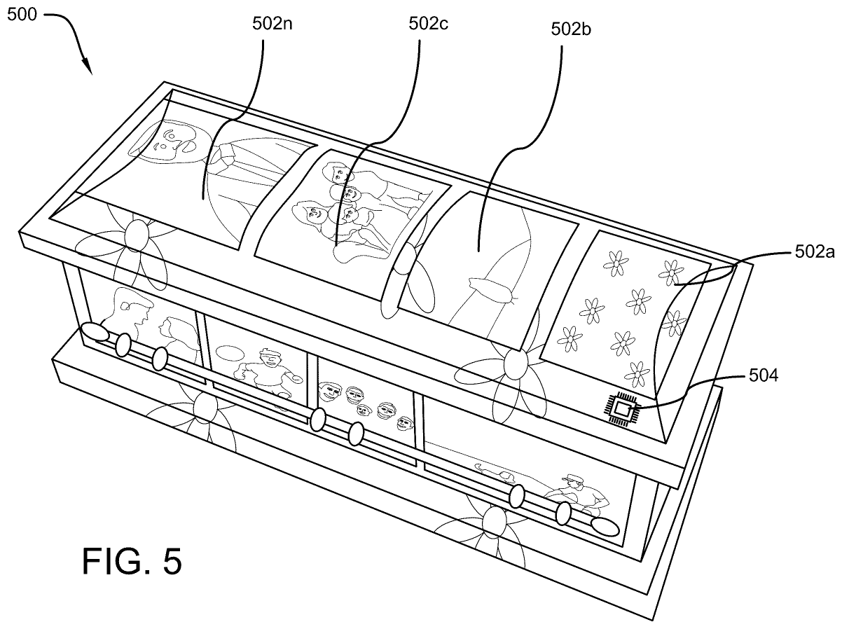

FIG. 5 illustrates another embodiment of the customized coffin cover device 100 of the present invention in accordance with the disclosed structure. In the present embodiment, the personalized coffin cover 500 includes a plurality of interchangeable panels 502a-n, allowing different designs for different ceremonies (e.g., religious service, military tribute, etc.). The panels 502a-n can be used to cover selected portions of the coffin. The cover device 500 also includes a scent release module 504 for releasing a custom fragrance associated with the deceased individual, the fragrance is comprised of but not limited to perfume, flowers, natural scents, or other familiar aromas.

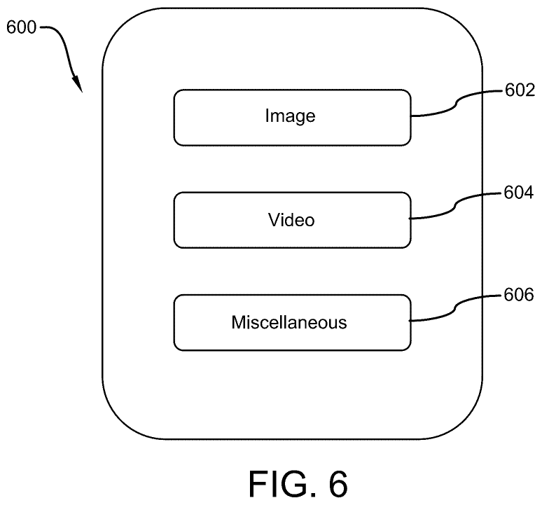

FIG. 6 illustrates a perspective view of an exemplary digital memorial page 600 shown on scanning of the interactive element in accordance with one embodiment of the present invention. As illustrated, the digital page 600 includes an image folder 602 which includes a plurality of images related to the deceased. A video folder 604 includes a plurality of videos featuring the deceased along with friends and family. A miscellaneous folder 606 can include achievements, career highlights, and more of the deceased in photo, video, audio, or text form.

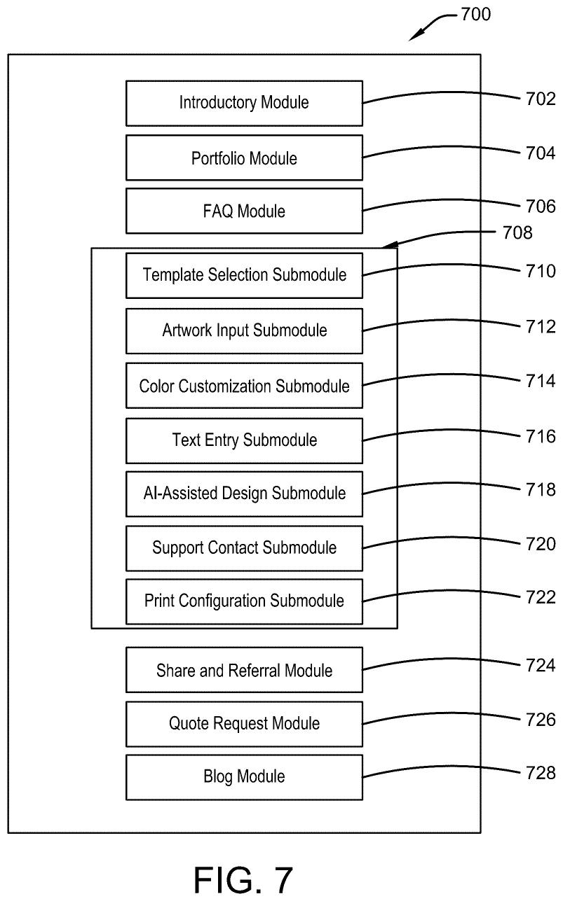

As seen in FIG. 7, the device 100 may be comprised of a mobile application 700. The application 700 is a user-interactive platform configured to provide information, customization options, and digital access to services associated with the personalized coffin cover device 100. The mobile application 700 includes an introductory module 702 configured to provide background information about the device 100 and/or any associated business, including mission, values, and an overview of available coffin cover customization services. A portfolio module 704 provides access to a gallery of sample coffin cover 100 designs, including various customization themes, finishes, and personalized options to guide users during selection. The mobile application 700 further comprises a FAQ module 706 configured to deliver detailed responses to common user inquiries. The FAQ module 706 includes, but is not limited to, topics such as: an explanation of what a coffin cover 100 is; how the coffin cover 100 is designed and produced; printing technologies used; available materials; and environmental considerations.

The application 700 includes a design interface module 708 featuring a self-service design tool. The design interface module 708 enables users to create personalized coffin cover 100 designs using a series of interactive steps. A template selection submodule 710 allows users to choose from a variety of predefined design templates and to specify coffin dimensions and configuration. An artwork input submodule 712 enables image, photo, or artwork uploads from local storage or connected devices. A color customization submodule 714 and text entry submodule 716 allow users to define color themes and input textual content such as names, quotes, or messages.

The design interface module 708 may include an AI-assisted design submodule 718 that generates personalized cover layouts using machine learning algorithms based on user inputs such as keywords, uploaded photos, or preferences. A support contact submodule 720 enables users to request assistance or a fully custom design service from a human designer. Once a design is finalized, a print configuration submodule 722 enables users to prepare the file for printing or save the completed design to a connected device. A share and referral module 724 allows users to refer the service to friends and family via digital means, including email or messaging applications. A quote request module 726 enables users to receive real-time cost estimates based on selected materials, design complexity, and delivery preferences. Additionally, a blog module 728 is provided to share stories, trends, updates, and educational content related to personalized funerary tributes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “customizable coffin wrap”, “customized coffin cover device”, “system”, “cover device”, “personalized coffin cover”, and “cover” are interchangeable and refer to the customizable coffin wrap device 100,500 of the present invention.

Notwithstanding the foregoing, the customizable coffin wrap device 100, 500 of the present invention can be of any suitable configuration as is known in the art without affecting the overall concept of the invention, provided that it accomplishes the stated above-stated objectives. One of ordinary skill in the art will appreciate that the customizable coffin wrap device 100, 500 as shown in the FIGS. are for illustrative purposes only, and that many other configurations of the customizable coffin wrap device 100, 500 are well within the scope of the present disclosure. Although the dimensions of the customizable coffin wrap device 100, 500 are important design parameters for user convenience, the customizable coffin wrap device 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A customizable coffin wrap comprising:
a top surface comprised of an indicia;
a machine-readable interactive element disposed on the top surface, the machine-readable interactive element configured to retrieve a digital memorial page; and
a bottom surface comprised of an adhesive layer.

2. The customizable coffin wrap of claim 1, wherein the machine-readable interactive element is comprised of a QR-code.

3. The customizable coffin wrap of claim 1, wherein the digital memorial page is comprised of a biography, a picture, a video, or an audio.

4. The customizable coffin wrap of claim 1, wherein the customizable coffin wrap is comprised of a biodegradable material.

5. The customizable coffin wrap of claim 1, wherein the customizable coffin wrap is comprised of a thermochromic material.

6. The customizable coffin wrap of claim 1, wherein the indicia is comprised of an image, a message, or a quote.

7. A customizable coffin wrap comprising:
a top surface comprised of an indicia, wherein the top surface is comprised of a scent release module;
a machine-readable interactive element disposed on the top surface, the machine-readable interactive element configured to retrieve a digital memorial page; and
a bottom surface comprised of an adhesive layer.

8. The customizable coffin wrap of claim 7, wherein the machine-readable interactive element is comprised of a QR-code.

9. The customizable coffin wrap of claim 7 wherein the customizable coffin wrap is comprised of a thermochromic material.

10. The customizable coffin wrap of claim 7, wherein the scent release module is comprised of a perfume scent.

11. The customizable coffin wrap of claim 7, wherein the scent release module is comprised of a flower scent.

12. The customizable coffin wrap of claim 7, wherein the scent release module is comprised of a natural scent.

13. The customizable coffin wrap of claim 7 further comprised of a panel.

14. The customizable coffin wrap of claim 7, wherein the machine-readable interactive element is comprised of a QR-code.

15. The customizable coffin wrap of claim 7, wherein the digital memorial page is comprised of a biography, a picture, a video, or an audio.

16. The customizable coffin wrap of claim 7, wherein the customizable coffin wrap is comprised of a biodegradable material.

17. The customizable coffin wrap of claim 7, wherein the customizable coffin wrap is comprised of a thermochromic material.

18. The customizable coffin wrap of claim 7, wherein the indicia is comprised of an image, a message, or a quote.

19. The customizable coffin wrap of claim 7, wherein the digital memorial page is comprised of an achievement or a career highlight.

20. A method of manufacturing a customizable coffin wrap, the method comprising the following steps:
selecting a cover material;
customizing the cover material by incorporating an indicia representing an attribute of a deceased individual;
generating a wrap template based on a coffin size and a coffin shape;
printing the indicia on the cover material;
applying an adhesive layer to a bottom surface of the cover material; and
dimensioning the customized coffin wrap using a laser cutting.
